(19) United States
(12) Patent Application Publication
(10) Pub. No.: US 2021/0023715 A1
(43) Pub. Date: Jan. 28, 2021

(54) Incorporating Vision System and In-Hand Object Location System for Object Manipulation and Training

(71) Applicant: ABB Schweiz AG, Baden (CH)

(72) Inventors: Biao Zhang, West Hartford, CT (US); Yixin Liu, South Windsor, CT (US); Thomas A. Fuhlbrigge, Ellington, CT (US); Saumya Sharma, Albany, NY (US)

(73) Assignee: ABB Schweiz AG, Baden (CH)

(21) Appl. No.: 16/521,025

(22) Filed: Jul. 24, 2019

(51) Int. Cl. B25J 9/16

(52) U.S. Cl. CPC B25J 9/1697; B25J 9/1692; B25J 9/163

(57) ABSTRACT

A system and method of object manipulation and training including providing at least one robotic hand including a plurality of grippers connected to a body and providing a plurality of cameras disposed in a periphery surface of the grippers. The method also includes providing a plurality of tactile sensors disposed in the periphery surface of the grippers and actuating the grippers to grasp an object. The method further includes detecting a position of the object with respect to the robotic hand via a first image feed from the tactile sensors and detecting a position of the object with respect to the robotic hand via a second image feed from the cameras. The method also includes generating instructions to grip and manipulate an orientation of the object based on the first and the second image feeds for a visualization of the object relative to the robotic hand.

### BACKGROUND OF THE INVENTION

Industrial robots are well known in the art. Such robots are intended to replace human workers in a variety of assembly tasks. It has been recognized that in order for such robots to effectively replace human workers in increasingly more delicate and detailed tasks, it will be necessary to provide sensory apparatus for the robots which is functionally equivalent to the various senses with which human workers are naturally endowed, for example, sight, touch, etc.

In robotic picking applications for small part assembly, warehouse/logistics automation, food and beverage, etc., a robot gripper needs to pick an object, then insert/place it accurately into another part. There are some traditional solutions: (1.) Customized fingers on the gripper can self-align the part to a fixed location relative to the gripper. But for different shape of the part, a different type of finger has to be made and changed. (2.) After picking up the part, the robot brings the part in front of a camera and a machine vision system detects the location of the part relative the gripper. But this extra step increases the cycle time for the robot system. (3.) The part is placed on a customized fixture and the robot is programmed to pick up the part at the same location each time. But various fixtures have to be made for different parts which may not be cost effective to produce.

Of particular importance for delicate and detailed assembly tasks is the sense of touch. Touch can be important for close-up assembly work where vision may be obscured by arms or other objects, and touch can be important for providing the sensory feedback necessary for grasping delicate objects firmly without causing damage to them. Touch can also provide a useful means for discriminating between objects having different sizes, shapes or weights. Accordingly, various tactile sensors have been developed for use with industrial robots.

However, there are problems such as easy wear and tear damage with this sensor for robotic picking and assembly applications that need to be overcome. In this problem, the robot hand is constantly picking parts and assembling parts which means that the finger/gripper surface is prone to abrasion/wear. This implies that any tactile sensing which employs fragile thin film coatings at grip points can easily wear off. Also, any elaborate light/LED source configuration limits the size of the in-hand object location system. An additional problem is the size of the light source and sensor are too big to mount on small robotic fingers to pick up small objects. Thus, mounting an elaborate light source for in-hand perception is not feasible. The current state of the art lacks information on object handling/gripping as a part of the robot hand.

Further, there are problems such as easy wear and tear damage with this sensor for robotic picking and assembly applications that need to be overcome. In this problem, the robot hand is constantly picking parts and assembling parts which means that the finger/gripper surface is prone to abrasion/wear. This implies that any tactile sensing which employs fragile thin film coatings at grip points can easily wear off. Also, such an elaborate light/LED source limits the size of the in-hand object location system. Therefore, an additional problem is the size of the light source and sensor may be too big to mount on small robotic fingers to pick up small objects. Thus, mounting an elaborate light source for in-hand perception is not feasible. Another problem is that adding an in-hand light source and detector means that there will be a need for an extra calibration step.

Another problem is most robot picking/grasping/manipulation has the lack of information about the object with reference to the gripper or the hand itself. A further problem is that there is usually a compromise in the quality of image, usually a low resolution image. Also, there is a problem of using up high engineer time and cost to design, build, install and tune a robotic picking and assembly system, especially when the system includes a vision system, customized fingers and fixtures to handle parts with different shapes. It is typical for an engineer to spend time to exchange the fingers, set up fixtures and change robot programs for different parts.

### BRIEF SUMMARY OF THE INVENTION

The invention is a method of object manipulation and training including providing at least one robotic hand including a plurality of grippers connected to a body and providing a plurality of cameras disposed in a periphery surface of the plurality of grippers. The method also includes providing a plurality of tactile sensors disposed in the periphery surface of the plurality of grippers and actuating the plurality of grippers to grasp an object. The method further includes detecting a position of the object with respect to the at least one robotic hand via a first image feed from the plurality of tactile sensors and detecting a position of the object with respect to the at least one robotic hand via a second image feed from the plurality of cameras. The method also includes generating instructions to grip and manipulate an orientation of the object based on the first and the second image feeds for a visualization of the object relative to the at least one robotic hand. The at least one robotic hand, the plurality of grippers, the plurality of cameras and the plurality of tactile sensors are electrically connected to a controller.

The invention is a robotic hand including a plurality of grippers and a body and a plurality of cameras disposed in a peripheral surface of the plurality of grippers. The robotic hand also includes at least one illumination surface disposed on a periphery surface of the plurality of grippers and a plurality of tactile sensors disposed in the peripheral surface of the plurality of grippers. The at least one robotic hand, the plurality of grippers, the plurality of cameras, the at least one illumination surface and the plurality of tactile sensors are electrically connected to a controller.

The invention is a non-transitory computer-readable medium storing instructions that, when executed by a processor of a computer, cause the processor to perform operations including actuating the plurality of grippers to grasp an object and detecting a position of the object with respect to the at least one robotic hand via a first image feed from the plurality of tactile sensors. Operations also include detecting a position of the object with respect to the at least one robotic hand via a second image feed from the plurality of cameras and generating instructions to grip and manipulate an orientation of the object based on the first and the second image feeds for a visualization of the object relative to the at least one robotic hand. Operations further include performing a pick procedure on the object based on the generated instructions and determining whether or not the image feeds from the visualization of the object correlates with the generated instructions. Operations also include correcting the gripping and manipulating of the object based on the determining and placing the object in an assembly of parts.

### BRIEF DESCRIPTION OF THE SEVERAL VIEWS OF THE DRAWING(S)

FIG. 1 is a perspective view of a pick and place assembly device according to an embodiment.

FIG. 2A is a perspective view of a tactile sensor according to an embodiment according to an embodiment.

FIG. 2B is a perspective view of another tactile sensor according to an embodiment.

FIG. 3A is a perspective view of a 3D sensor film according to an embodiment.

FIG. 3B is a perspective view of a 3D reconstruction of an object disposed on the 3D sensor film of FIG. 3A.

FIG. 4A is a diagrammatic view of the structure of a 3D in-hand sensor according to an embodiment.

FIG. 4B is a perspective view of the 3D in-hand sensor of FIG. 4A.

FIG. 5A is a plan view of an in-hand object location and vision system according to an embodiment.

FIG. 5B is a diagrammatic view of a tactile sensor according to an embodiment.

FIG. 6 is a workflow chart of an offline trained network according to an embodiment.

FIG. 7 is a schematic view of a distributed control system architecture for the object location and vision system according to an embodiment.

FIG. 8 is a flowchart of a set up and run time method for the in-hand object location and vision system according to an embodiment.

FIG. 9 is a flowchart of a set up and run time method for the in-hand object location and vision system according to another embodiment.

FIG. 10 is a flowchart for a method of object manipulation and training according to an embodiment.

FIG. 11 is a block diagram of a storage medium storing machine-readable instructions in according to an embodiment.

FIG. 12 is a flow diagram for a system process contained in a memory as instructions for execution by a processing device coupled with the memory according to an embodiment.

### DETAILED DESCRIPTION OF THE INVENTION

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The invention particularly describes the use of computer-aided design (CAD) model/synthetic data of the objects being handled/assembled, together with the tactile imaging information with reference to a robotic hand, and the robot joint coordinate information that is easily accessible as well. This pool of information can allow coordinated movement and easy manipulation of the object which is being picked or assembled. This pool of information may also allow for easier forecasting of robot gestures or grasp planning.

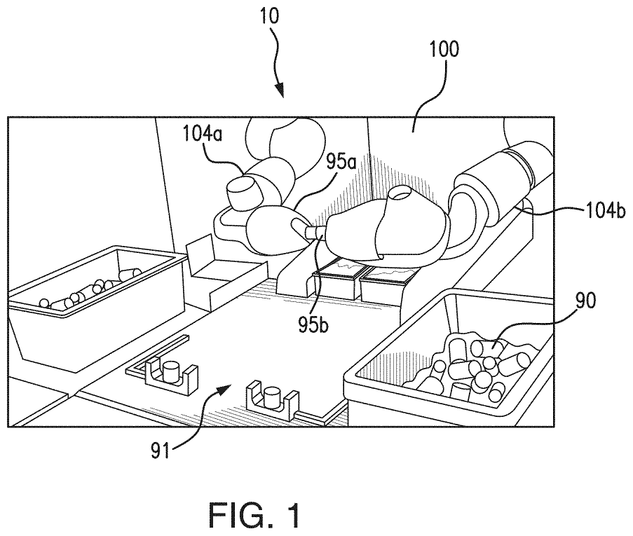

Referring now to FIG. 1, this is a robot button switch picking and assembly system 10. In many applications, a robot body portion 100 including a first robot arm 104a and a second robot arm 104b configured to provide degrees of freedom to a robot gripper/finger 95a, 95b needs to know the accurate location of a part/workpiece 90 relative to a robot gripper 95a, 95b after the robot picks up the part/workpiece 90 and moves it towards work area 91. In certain embodiments, system 10 includes an in-hand object location device, as discussed below.

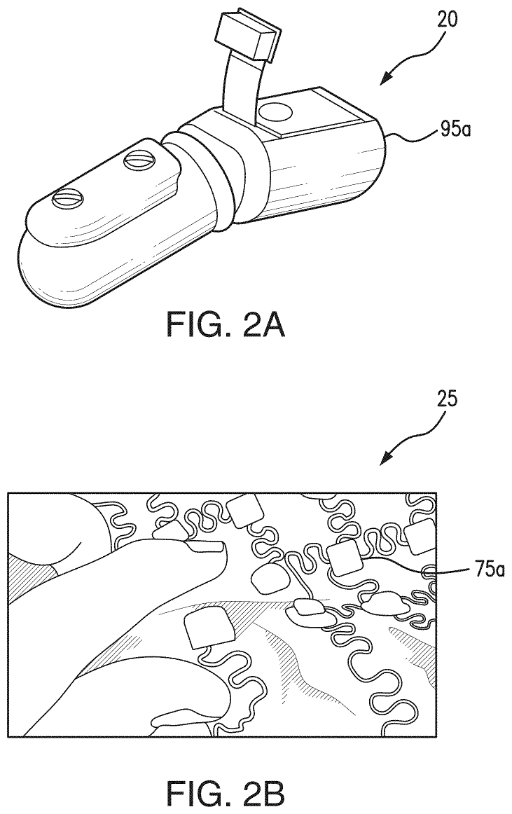

Referring now to FIGS. 2A and 2B, there are a tactile sensors 20, 25 having gripping surfaces 75a used for in-hand object location. A tactile sensor is a device that can measure contact forces between the part 90 and the gripper 95a, 95b. These sensors may be mounted or incorporated on or within a robot gripper finger 95a and may be used to detect the in-hand object location.

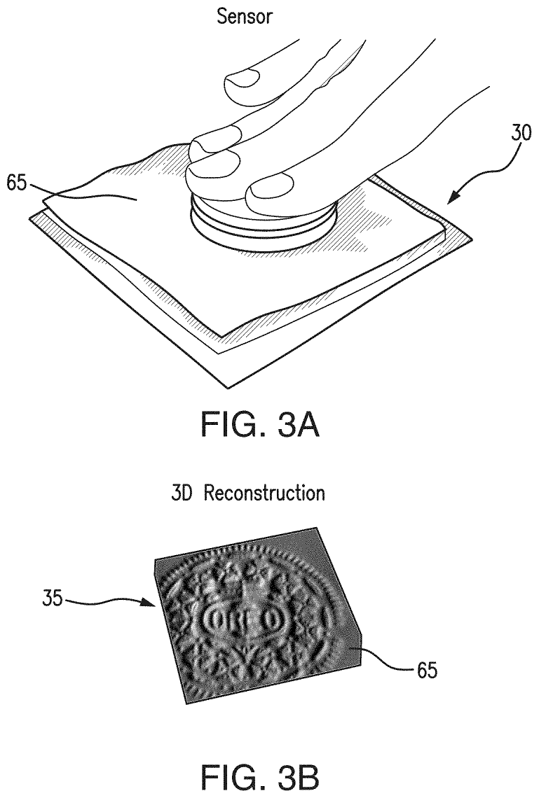

Referring now to FIGS. 3A and 3B, there is an in-hand sensor film 30, for example a GELSIGHT sensor gel film, provides high resolution (up to 2 micron) 3D reconstruction 35 of the geometry of an in-hand object as taught in U.S. Pat. Pub. 2014/0104395, entitled Methods of and System for Three-Dimensional Digital Impression and Visualization of Objects through an Elastomer, filed Oct. 17, 2013 the subject matter of which is incorporated by reference in its entirety herein. In some embodiments, film 30 may include a pressure-sensitive layer 65 configured to capture the 3D reconstruction 35 of an object it contacts to create a digital representation of the object as shown for example in FIG. 3B.

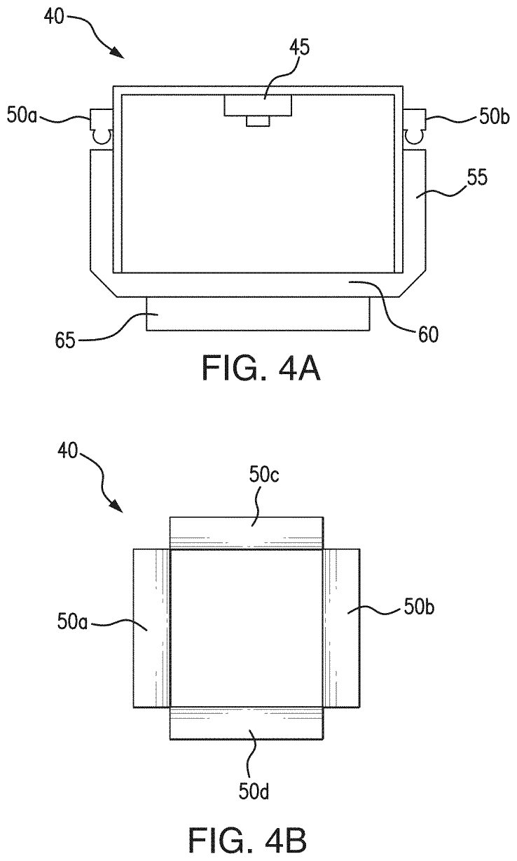

Referring now to FIGS. 4A and 4B, there is an in-hand sensor 40. Sensor 40 can be used to provide highly accurate location of in-hand object and may include a camera 45, LEDs 50a-d, light guide plate 55, a support plate 60 and elastomer gel 65 similar to sensor film 30 of FIG. 3A.

Further, the in-hand sensor 40 may include a block of transparent rubber or gel, one face of which is coated with metallic paint. When the paint-coated face is pressed against an object, it conforms to the object's shape. The metallic paint makes the object's surface reflective, so its geometry becomes much easier for computer vision algorithms to infer. Mounted on the sensor opposite the paint-coated face of the rubber block are colored lights/LEDs 50a-d and a single camera 45. This system needs to have colored lights at different angles, and then it has the reflective material, and by looking at the colors, a computer can figure out a 3-D shape of what is being sensed or touched.

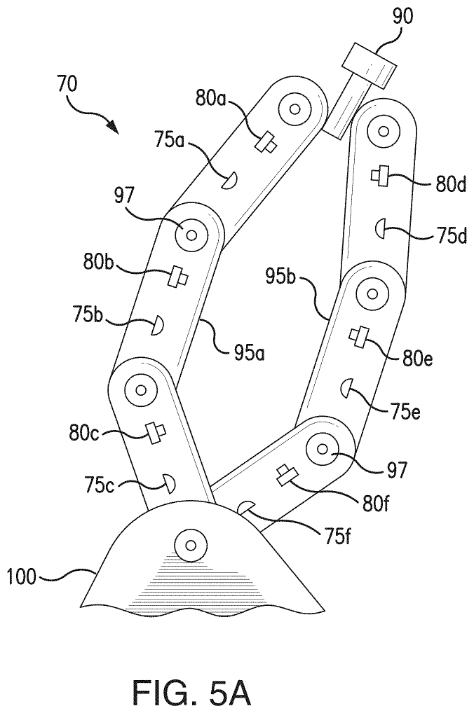

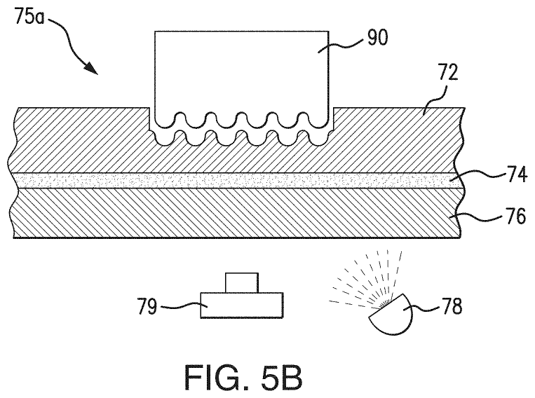

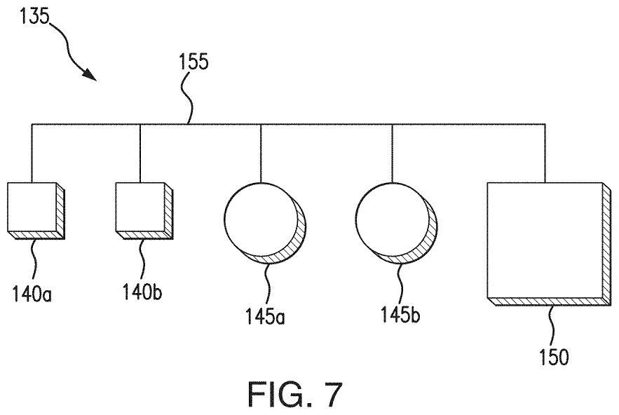

Referring now to FIG. 5A, there is a plan view of an in-hand object location and vision system 70 including a robotic hand having a plurality of in-hand cameras 80a to 80f (vision system), a plurality of in-hand tactile sensors 75a to 75f (in-hand image), an object 90, at least two grippers 95a, 95b having linkages 97 disposed within the at least two grippers 95a, 95b and a body portion 100. In certain embodiments, object 90 may be in the form of a workpiece. The plurality of cameras 80a to 80f may comprise a fish eye lens disposed therein to capture and send/feed the maximum image information to a vision array 140b (FIG. 7) electrically connected to the same. The fish eye lens used with in-hand object location and vision system 70 may obtain more information than a regular lens. The plurality of tactile sensors 75a to 75f may be configured to capture and send/feed image information to a tactile sensor array 140a electrically connected to the same.

In some embodiments, an in-hand object location system may be used to determine the location of a part held within a robotic hand. This system may additionally provide information about the geometry of the object 90. This system may also be used to find a different location that may provide a better grasp of the object 90. Such an in-hand object location system requires a light source and a detector or camera unit within the robotic hand. Mounting an elaborate light source while maintaining a compact robot hand/fingers may be challenging, but the tactile architecture as described makes it possible to do so.

Since some in-hand object location systems may be limited in field of view and resolution, it can prove very beneficial to combine an in-hand object location system (75a to 75f) with a vision system (80a to 80f) as described herein below. Such an in-hand object location and vision system 70 may provide information about the 3D geometry of the object 90. This system 70 may also be used to find a different location that may provide a better grasp of the object 90. Incorporating the information of an in-hand object location system with that of a 2D/3D vision system together, facilitates a robot system to accurately and robustly pick, place and assembled objects/workpieces. This type of configuration reduces the engineering time and cost to design, build, install and tuning the system. Such a configuration may also reduce the cycle time.

In some embodiments, the plurality of in-hand tactile sensors 75a to 75f each include a layer of pressure generated illumination surfaces comprised of pressure sensitive luminescent films. Using an in-hand object location system with pressure sensitive illumination can allow easy perception of the part of an object that has been gripped without the need for an elaborate light source. Illumination surfaces may generate enough light to act as a light source for cameras 80a to 80f to receive better imagery of object 90 as it is manipulated in-hand. In some embodiments, surfaces illuminate upon coming into contact with an object 90 via a pressure-activated glow effect triggered by pressure on object 90. Tactile sensors 75a to 75f, cameras 80a to 80f and grippers 95a, 95b may be electrically and mechanically connected to a power source and control system 135 (FIG. 7) as described below.

Referring now to FIG. 5B, there is a tactile sensor 75a of the plurality of in-hand tactile sensors disposed on a surface of gripper 95a may include a first elastomer 72 disposed on a first side of a reflective film 74, a second elastomer 76 disposed on a second side of the reflective film 74, a light source 78 directed towards and incident upon the second elastomer 76, and a camera 79 directed towards the second elastomer 76 to capture a 3D image of object 90 in a similar manner as shown in FIGS. 3A and 3B. In certain embodiments, elastomer 76 has a transparent or semi-transparent coating sandwiched adjacent the reflective film 74 as shown. First elastomer 72 is disposed and configured to be impacted by an object 90 to be sensed using tactile and 3D imaging via camera 79. By sandwiching the reflective film 74 between elastomers 72 and 76 any peeling of the reflective film 74 may be prevented during repetitive use, contact or manipulation of object 90 thereby making the tactile sensor 75c more durable over time. In some embodiments, tactile sensor 75a may include both a tactile and an illumination surface combination to view and manipulate object 90 during use.

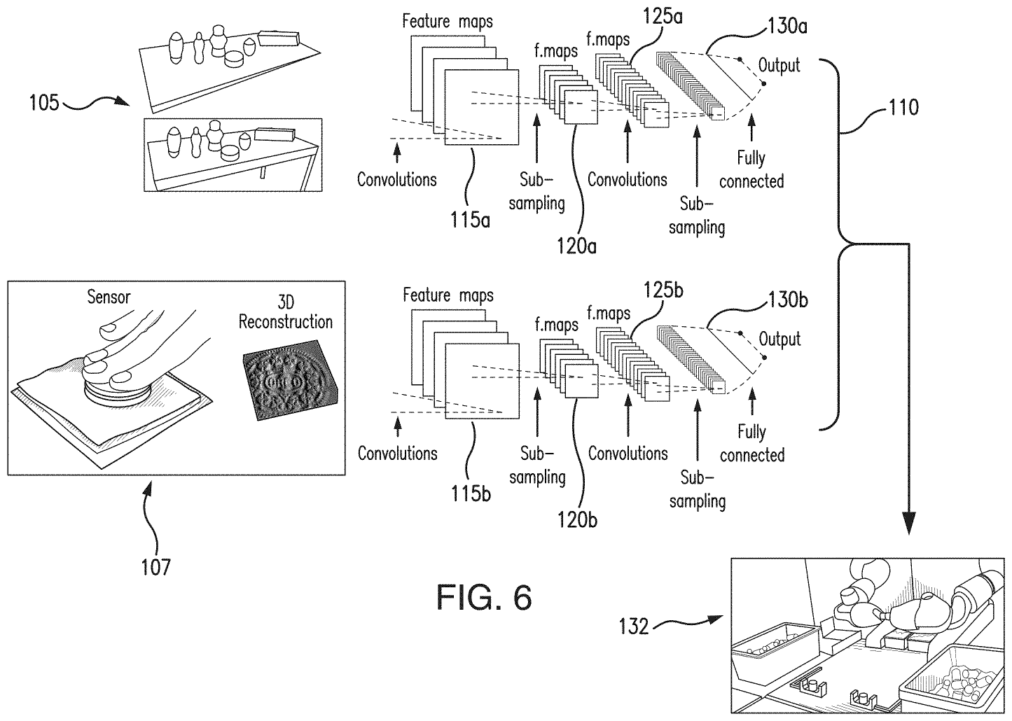

Referring now to FIG. 6, there is a workflow chart of an offline trained network illustrating the 2D/3D vision system 105 which provides the location and geometry information of the parts before the parts are picked and assembled and the in-hand object location and vision system 70 (for example tactile sensor 75a in FIG. 5B) provides highly accurate location information and 3D geometry of the object 90 in robot hand/gripper after the parts are picked.

An offline trained model 110 (for example deep learning Convolution neural network) as shown in FIG. 6 may be based on the inputs from both 2D/3D vision system and in-hand object location and vision system 70 generates the robot programs for picking part, placing part and assembly of parts. The model 110 shown in FIG. 6 directly connects the object in-hand 107 and out-of-hand visual information 105 to the robot picking, placing and assembly robot movement 132. This End-to-End model 110 simplifies the training and system setup process. A user does not need to select the visual features of the object 90 for image processing, nor for tuning the parameter of image processing (2D/3D). Also the user does not need to teach robot picking, placing and assembly movement into robot program.

In the offline training phase, the robot system automatically conducts the experiments to pick, place and assembly the parts and collects part information from 2D/3D vision system and in-hand object location and vision system 70 as well as the robot movement with the successful and fail of the picking, placing and assembly task. The initial robot picking, placing and assembly movement can come either from manual teaching or a general purpose model (the model trained for general part and tasks). In FIG. 6, the visual information 105 is applied to model 110 for the vision system image (out-of-hand) recognition, image classification, object detection (object position and orientation), etc. In certain embodiments, model 110 takes an input image at 105 processes it and classifies it via a computer program coded to process a neural network with many convolutional layers having feature maps 115a to subsampling feature maps 120a to feature maps 125a to more subsampling feature maps 130a and ultimately to outputs of image recognition. Similarly, in model 110 for the in-hand object image recognition and object detection (object position and orientation), model 110 takes an input image at 107 processes it and classifies it via a computer program coded to process a neural network with many convolutional layers having feature maps 115b to subsampling feature maps 120b to feature maps 125b to more subsampling feature maps 130b and ultimately to outputs of image recognition and object detection (object position and orientation).

The novel idea here is not only to use both the 2D/3D vision system and the in-hand object location system 70, which provides in hand location information after picking part, to guide robot movement 132. It allows offline training in an end-to-end model by simplifying the training phase.

Referring now to FIG. 7, there is a distributed control system 135 configured to operate and control the sensors 75a-f and the cameras 80a-f, as well as the robotic appendage or grippers 95a, 95b electro-mechanically connected via linkages 97 to body 100 discussed above. System 135 may include components, such as, a tactile sensor array 140a, a vision array 140b, an acute actuator control module 145a, a gross actuator control module 145b and a central controller 150 all connected via a communication bus 155 configure to pass at least two-way signals between all components. The tactile sensor array 140a may be electrically connected to sensors 75a-f in a feedback loop to control the movement of grippers 95a, 95b with respect to, for example, a pick and place operation for object 90. The vision array 140b may be electrically connected to cameras 80a-f in a feedback loop to control the relative movement of grippers 95a, 95b with respect to, for example, a pick and place operation for object 90. The acute actuator control module 145a is configured to control small and precise motion of grippers 95a, 95b and the gross actuator control module 145b is configured to control large or gross motion of gripper 95a, 95b during, for example, a pick and place operation. Central controller 150 may include a computer processor (CPU), an input/output (I/O) unit and a programmable logic controller (PLC) configured to program and operate the in-hand object location and vision system 70 described herein.

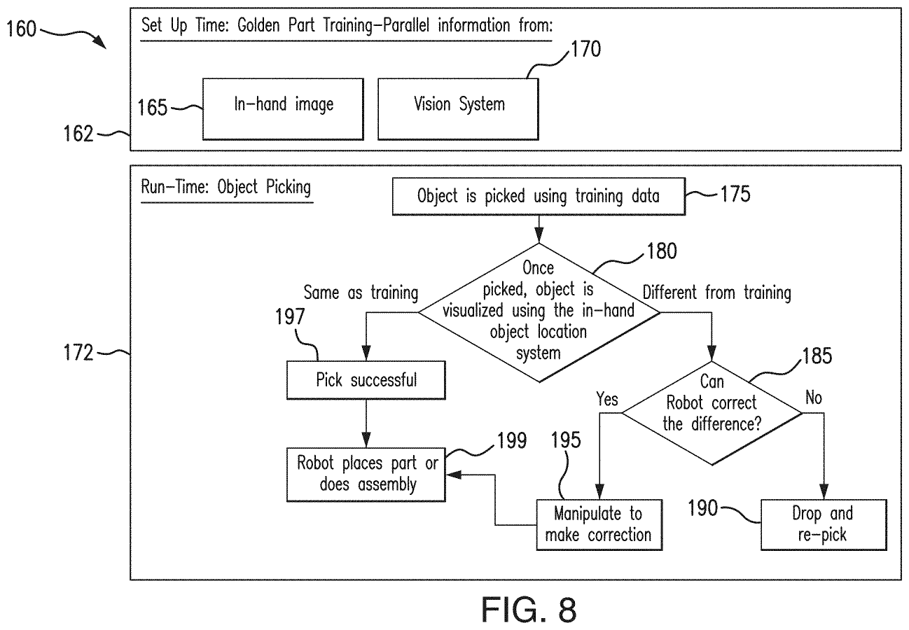

Referring now to FIG. 8, there is a flowchart of a set up time 162 and run time 172 of method 160 for the in-hand object location and vision system 70 including the set up time step 162 in which an in-hand object location system 165 and a vision system 170 are configured to allow for a much better perception of surroundings and context if both of these systems (165, 170) are used in combination as discussed above at 70. This combination of a low resolution in-hand object location system 165 and a vision system 170 of the robot may significantly improve image and object recognition and training. The result is that the set up time step 162 is significantly shorter due to the extra sensing ability available with the in-hand object location and vision system 70. In certain embodiments, the golden part training at 162 includes information from two parallel sources: 1) In-hand image 165 and 2) vision system 170.

In FIG. 8, the run time step 172 is much shorter as well. It is more efficient mostly because of the process flexibility and newfound sensing ability owing to the in-hand object location and vision system 70. At 175, the object 90 is picked and then compared against the golden part training or set up time step 162. At 180, if the object 90 is picked in the same way as trained, then at 197 the pick is successful and at 199 the robotic hand places the object 90 or does an assembly operation without any correction. At 185, if the object 90 is picked in a way that is different from training, then at 195 the robotic hand can correct the difference by manipulating the object 90 using in-hand object location and vision system 70 that has provided better sensing ability, and using the additional data which was collected during the golden part training at 162 from all both parallel information sources (165, 170). At 190, if the correction is not possible, then the part is dropped and re-picked.

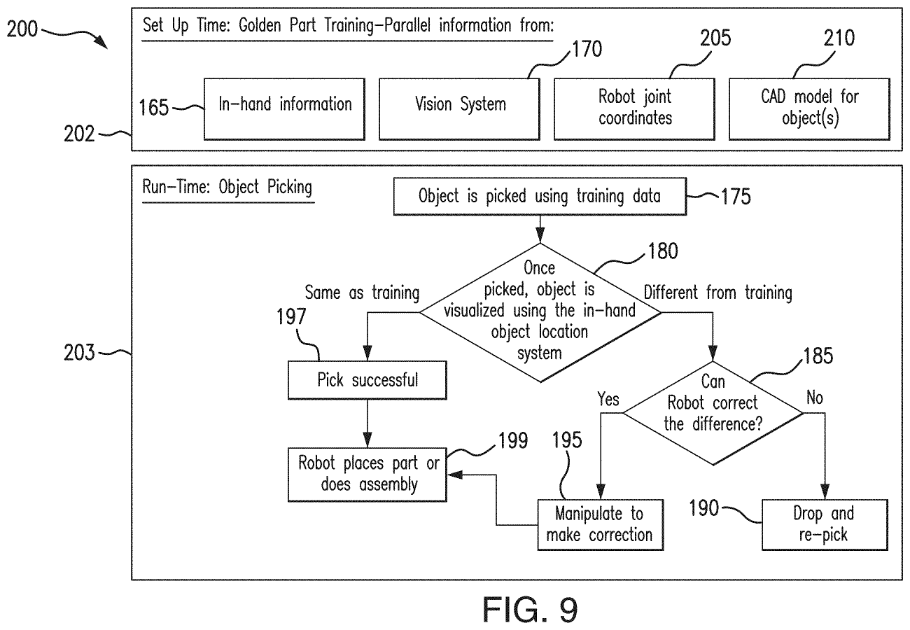

Referring now to FIG. 9, there is a flowchart of a set up time 202 and run time 203 method 200 for the in-hand object location and vision system 70 according to another embodiment. In certain embodiments, the robotic hand is equipped with a compact tactile sensor 75a to 75f detects movement and manipulation of the object 90 with respect to the robotic hand. Basically, this allows the robot to have significantly more information which may all be used in parallel to optimize the planning and execution phase of method 200. In some embodiments, four parallel data sources may be used, such as, synthetic data 210, such as a computer-aided design (CAD) model about the object 90 being handled/assembled, tactile imaging information 165 with reference to the robotic hand, robot vision system information 170 and robot joint coordinate information 205, with reference to each movement in robot hand/arm. This pool of information may allow coordinated movement and easy manipulation of the object 90 which is being picked or assembled. This pool of information also allows easier forecasting of robot gestures or grasp planning.

The set up time step 202 is significantly shorter due to extra sensing ability available with the in-hand object location and vision system 70. Thus, the golden part training at 202 may include information from four sources working in parallel: 1) In-hand image 165, 2) vision system 170, 3) robot joint coordinates 205 and 4) synthetic information about object 210.

In FIG. 9, the run time step 203 is much shorter as well. It is more efficient mostly because of the process flexibility and newfound sensing ability owing to the in-hand object location and vision system 70. At 175, the object 90 is picked and then compared against the golden part training at 202. At 180, if the object 90 is picked in the same way as trained, then at 197 the pick is successful and at 199 the robotic hand places the object 90 or does an assembly operation without any correction. At 185, if the object 90 is picked in a way that is different from training, then at 195 the robotic hand can correct the difference by manipulating the object 90 using in-hand object location and vision system 70 that has provided better sensing ability, and using the additional data which was collected during the golden part training at 202 from all both parallel information sources (165, 170, 205, 210). At 190, if the correction is not possible, then the part is dropped and re-picked.

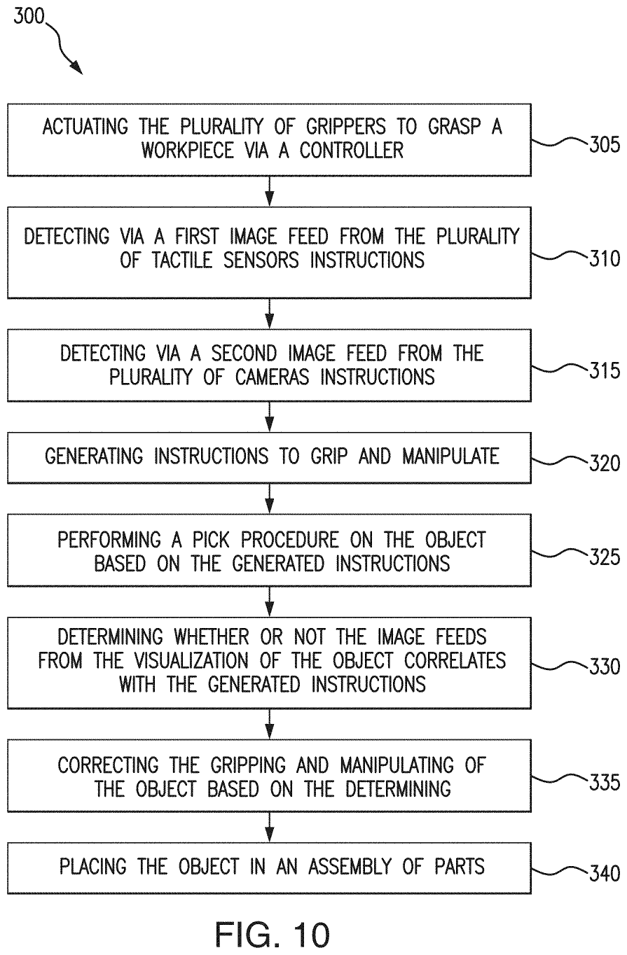

Referring now to FIG. 10, there is a method 300 of object manipulation and training according to an embodiment. Method 300 includes at 305 actuating the plurality of grippers to grasp an object via a controller. At, 310, the method 300 includes detecting a position of the object with respect to the at least one robotic hand via a first image feed from the plurality of tactile sensors. At 315, the method 300 includes detecting a position of the object with respect to the at least one robotic hand via a second image feed from the plurality of cameras. At 320, the method 300 includes generating instructions to grip and manipulate an orientation of the object base3d on the first and the second image feeds for visualization of the object relative to the at least one robotic hand. At 325, the method 300 includes performing a pick procedure on the object based on the generated instructions. At 330, the method 300 includes determining whether or not the image feeds from the visualization of the object correlates with the generated instructions. At 335, the method 300 includes correcting the gripping and manipulating of the object based on the determining. At 340, the method 300 includes placing the object in an assembly of parts.

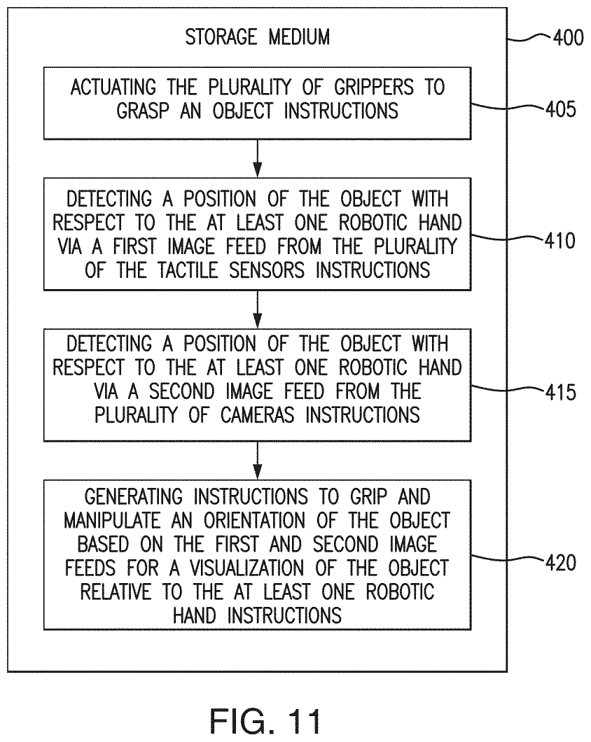

Referring now to FIG. 11, there is a block diagram for a system process contained in a memory as instructions for execution by a processing device coupled with the memory, in accordance with an exemplary embodiment of the disclosure. The instructions included on the non-transitory computer readable storage medium 400 cause, upon execution, the processing device of a vendor computer system to carry out various tasks. In the embodiment shown, the memory includes actuating instructions 405 for a plurality of grippers, using the processing device. The memory further includes detecting instructions 410 for a position of the object with respect to the at least one robotic hand via a first image feed from the plurality of tactile sensors, and detecting instructions 415 for a position of the object with respect to the at least one robotic hand via a second image feed from the plurality of cameras. The memory 400 further includes generating instructions 420 for gripping and manipulating an orientation of the object based on the first and the second image feeds for a visualization of the object relative to the at least one robotic hand.

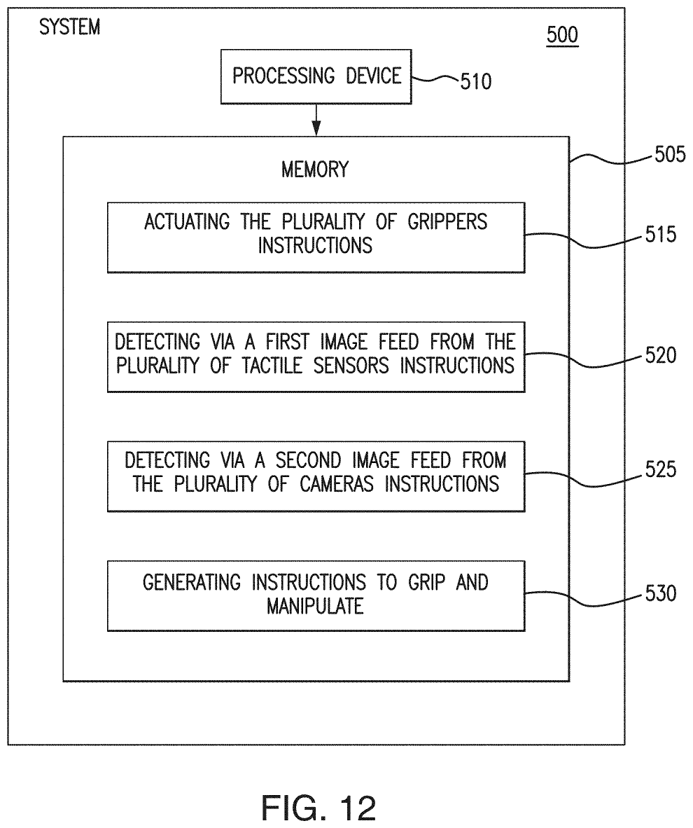

Referring now to FIG. 12, there is a flow diagram for a system process contained in a memory as instructions for execution by a processing device coupled with the memory according to an embodiment. In this embodiment, the system 500 includes a memory 505 for storing computer-executable instructions, and a processing device 510 operatively coupled with the memory 505 to execute the instructions stored in the memory. The processing device 510 is configured and operates to execute actuating instructions 515 for the plurality of grippers, and detecting instructions 520 for a first image feed from the plurality of tactile sensors. Further, processing device 510 is configured and operates to execute detecting instructions 525 for a second image feed from the plurality of cameras, and generating instructions 530 for gripping and manipulating an orientation of the object based on the first and second image feeds for a visualization of the object relative to the at least one robotic hand.

Using this invention, a robotic system can use a general purpose finger/gripper with or without a general purpose fixture to pick, place and assemble various parts.

The various embodiments described herein may provide the benefits of a reduction in the engineering time and cost to design, build, install and tune a special finger, or a special fixture, or a vision system for picking, placing and assembly applications in logistics, warehouse or small part assembly. Also, these embodiments may provide a reduction in cycle time since the robotic hand can detect the position of the in-hand part right after picking the part. Further, these embodiments may provide improved robustness of the system. In other words, with the highly accurate in-hand object location and geometry, the robot can adjust the placement or assembly motion to compensate for any error in the picking. Moreover, these embodiments may be easy to integrate with general purpose robot grippers, such as the robotic YUMI hand, herein incorporated by reference, for a wide range of picking, placing and assembly applications.

The techniques and systems disclosed herein may be implemented as a computer program product for use with a computer system or computerized electronic device. Such implementations may include a series of computer instructions, or logic, fixed either on a tangible/non-transitory medium, such as a computer readable medium 400 (e.g., a diskette, CD-ROM, ROM, flash memory or other memory or fixed disk) or transmittable to a computer system or a device, via a modem or other interface device, such as a communications adapter connected to a network over a medium.

The medium 300 may be either a tangible medium (e.g., optical or analog communications lines) or a medium implemented with wireless techniques (e.g., Wi-Fi, cellular, microwave, infrared or other transmission techniques). The series of computer instructions (e.g., FIG. 12 at 515, 520, 525, 530) embodies at least part of the functionality described herein with respect to the system 500. Those skilled in the art should appreciate that such computer instructions can be written in a number of programming languages for use with many computer architectures or operating systems.

Furthermore, such instructions (e.g., at 500) may be stored in any tangible memory device 505, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Thus, it will be appreciated that the scope of the present invention is not limited to the above described embodiments, but rather is defined by the appended claims; and that these claims will encompass modifications of and improvements to what has been described.

Preferred embodiments of this invention are described herein, including the best mode known to the inventors for carrying out the invention. Variations of those preferred embodiments may become apparent to those of ordinary skill in the art upon reading the description herein. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of object manipulation and training, comprising:
providing at least one robotic hand including a plurality of grippers connected to a body;
providing a plurality of cameras disposed in a periphery surface of the plurality of grippers;
providing a plurality of tactile sensors disposed in the periphery surface of the plurality of grippers;
actuating the plurality of grippers to grasp an object;
detecting a position of the object with respect to the at least one robotic hand via a first image feed from the plurality of tactile sensors;
detecting a position of the object with respect to the at least one robotic hand via a second image feed from the plurality of cameras; and
generating instructions to grip and manipulate an orientation of the object based on the first and the second image feeds for a visualization of the object relative to the at least one robotic hand,
wherein the at least one robotic hand, the plurality of grippers, the plurality of cameras and the plurality of tactile sensors are electrically connected to a controller.

2. The method of claim 1, wherein the plurality of cameras each include a fish eye lens and is disposed in the body of the at least one robotic hand.

3. The method of claim 1, further comprising providing at least one illumination surface disposed on the peripheral surface of the plurality of grippers.

4. The method of claim 3, wherein the at least one illumination surface is a pressure-activated luminescent surface.

5. The method of claim 1, wherein the plurality of grippers include mechanical linkages connecting the plurality of grippers to the body of the at least one robotic hand.

6. The method of claim 5, wherein the mechanical linkages include actuators configured to provide motion to the plurality of grippers via the controller.

7. The method of claim 3, wherein the at least one illumination surface is configured to provide a light source for the plurality of cameras.

8. The method of claim 1, wherein the controller comprises a tactile sensor array electrically connected to the plurality of tactile sensors, a vision array electrically connected to the plurality of cameras, an acute actuator control module and a gross actuator control module connected to the at least one robotic hand to move the plurality of grippers, and a central controller configured to connect to and to control each component via a communication bus.

9. The method of claim 1, wherein each of the plurality of tactile sensors comprises a reflective film sandwiched between at least two tactile layers, a light source and a camera.

10. The method of claim 9, wherein the at least two tactile layers are elastomers.

11. The method of claim 9, wherein the camera and the light source are disposed adjacent only one of the at least two tactile layers, and
wherein the light source and the camera are electrically connected to the controller to render a 3D image of a touched surface by the plurality of tactile sensors.

12. The method of claim 1, further comprising:
performing a pick procedure on the object based on the generated instructions;
determining whether or not the image feeds from the visualization of the object correlates with the generated instructions;
correcting the gripping and manipulating of the object based on the determining; and
placing the object in an assembly of parts.

13. The method of claim 12, wherein if the correcting fails, then dropping the object and performing a re-pick of the object.

14. A robotic hand, comprising:
a plurality of grippers and a body;
a plurality of cameras disposed in a peripheral surface of the plurality of grippers;
at least one illumination surface disposed on a periphery surface of the plurality of grippers; and
a plurality of tactile sensors disposed in the peripheral surface of the plurality of grippers,
wherein the at least one robotic hand, the plurality of grippers, the plurality of cameras, the at least one illumination surface and the plurality of tactile sensors are electrically connected to a controller.

15. The robotic hand device of claim 13, wherein the at least one illumination surface is a pressure-activated luminescent surface.

16. The robotic hand device of claim 13, wherein the plurality of grippers include mechanical linkages connecting the plurality of grippers to the body.

17. The robotic hand device of claim 15, wherein the mechanical linkages include actuators configured to provide motion to the plurality of grippers via the controller.

18. The robotic hand device of claim 13, wherein the at least one illumination surface is configured to provide a light source for the plurality of cameras.

19. A non-transitory computer-readable medium storing instructions that, when executed by a processor of a computer, cause the processor to perform operations comprising:
actuating the plurality of grippers to grasp an object;
detecting a position of the object with respect to the at least one robotic hand via a first image feed from the plurality of tactile sensors;
detecting a position of the object with respect to the at least one robotic hand via a second image feed from the plurality of cameras; and
generating instructions to grip and manipulate an orientation of the object based on the first and the second image feeds for a visualization of the object relative to the at least one robotic hand.

20. The operations of claim 19, further comprising:
performing a pick procedure on the object based on the generated instructions;
determining whether or not the image feeds from the visualization of the object correlates with the generated instructions;
correcting the gripping and manipulating of the object based on the determining; and
placing the object in an assembly of parts.
